(19) United States
(12) Patent Application Publication
(10) Pub. No.: US 2012/0060519 A1
(43) Pub. Date: Mar. 15, 2012

(54) Cryopump and cryogenic refrigerator

(75) Inventor: Hidekazu Tanaka, Tokyo (JP)

(73) Assignee: SUMITOMO HEAVY INDUSTRIES, LTD., Tokyo (JP)

(21) Appl. No.: 13/137,788

(22) Filed: Sep. 13, 2011

(30) Foreign Application Priority Data
Sep. 13, 2010 (JP) 2010-204891

(51) Int. Cl. B01D 8/00

(52) U.S. Cl. 62/55.5

(57) ABSTRACT

A refrigerator includes a displacer coupling structure, wherein one of two coupled displacers protrudes into the other of the two coupled displacers to the extent that an end of a regenerator built in the one of the two coupled displacers positions itself inside of the other of the two coupled displacers. A cryopump includes: a low temperature cryopanel; a high temperature cryopanel arranged to be cooled to a temperature higher than that of the low temperature cryopanel; and the refrigerator.

### BACKGROUND OF THE INVENTION

1. Field of the Invention

The present invention relates to a cryopump and a cryogenic refrigerator.

2. Description of the Related Art

A cryopump having a refrigerator wherein a flow passage of operating gas at a joint between a first displacer and second displacer is branched into two operating gas flow passages is known. The first operating gas flow passage connects from the low-temperature end of a first regenerator to a first expansion room. The second operating gas flow passage directly connects from the low-temperature end of the first regenerator to a second regenerator. The second operating gas flow passage allows a part of the gas flowing into the second regenerator to flow into the second regenerator without passing through the first expansion room.

### SUMMARY OF THE INVENTION

A cryopump according to an exemplary embodiment of the present invention includes: a low temperature cryopanel; a high temperature cryopanel arranged to be cooled to a temperature higher than that of the low temperature cryopanel; and a refrigerator. The refrigerator is arranged to provide a low temperature cooling position for cooling the low temperature cryopanel and a high temperature cooling position for cooling the high temperature cryopanel, the low temperature cooling position and the high temperature cooling position being arranged longitudinally. The refrigerator includes a first displacer and a second displacer coupled with each other longitudinally. A high temperature end of the second displacer is contained in and coupled to a low temperature end of the first displacer so that a high temperature end of a regenerator built in the second displacer protrudes into the first displacer.

Another aspect of the present invention is a cryogenic refrigerator. The cryogenic refrigerator includes a displacer coupling structure, wherein one of two coupled displacers protrudes into the other of the two coupled displacers to the extent that an end of a regenerator built in the one of the two coupled displacers positions itself inside of the other of the two coupled displacers.

### BRIEF DESCRIPTION OF THE DRAWINGS

FIG. 1 schematically shows a cryopump according to an exemplary embodiment of the present invention;

FIG. 2 shows a substantial part of a refrigerator according to an exemplary embodiment of the present invention;

FIG. 3 shows flows of operating gas during a gas intake process in a refrigerator according to an exemplary embodiment of the present invention;

FIG. 4 shows flows of operating gas during a gas release process in the refrigerator according to an exemplary embodiment of the present invention;

FIG. 5 shows flows of operating gas during a gas intake process in a refrigerator according to another exemplary embodiment; and

FIG. 6 shows flows of operating gas during a gas release process in the refrigerator according to another exemplary embodiment.

### DETAILED DESCRIPTION OF THE INVENTION

The invention will now be described by reference to the preferred embodiments. This does not intend to limit the scope of the present invention, but to exemplify the invention.

In a cryopump, which is one of the typical applications of cryogenic refrigerators, a first cooling stage of a refrigerator is mounted to a first cryopanel having a cylindrical shape with a bottom. Since a second cooling stage is arranged inside of the first cryopanel, the length of a second cylinder that connects between the first cooling stage and the second cooling stage can be limited by the size of the first cryopanel. The length of the second cylinder is one of the main factors that determine the temperature difference between the first cooling stage and the second cooling stage. In this way, the structural requirement based on an apparatus to which the refrigerator is to be applied and the optimal design with respect to the cooling performance of the refrigerator do not always match.

It is desirable to provide a cryogenic refrigerator that can be more suitably designed for a target with which the refrigerator is to be utilized, and a cryopump utilizing the refrigerator.

A cryopump according to an aspect of the present invention includes: a low temperature cryopanel; a high temperature cryopanel arranged to be cooled to a temperature higher than that of the low temperature cryopanel; and a refrigerator arranged to provide a low temperature cooling position for cooling the low temperature cryopanel and a high temperature cooling position for cooling the high temperature cryopanel, the low temperature cooling position and the high temperature cooling position being arranged longitudinally, wherein the refrigerator includes a first displacer and a second displacer coupled with each other longitudinally, wherein a high temperature end of the second displacer is contained in and coupled to a low temperature end of the first displacer so that a high temperature end of a regenerator built in the second displacer protrudes into the first displacer.

According to the aspect of the invention, in order to cool the low temperature cryopanel and the high temperature cryopanel, the low temperature cooling position and the high temperature cooling position are provided with an arrangement adaptable to respective panels. By allowing the second displacer to protrude into the first displacer, the second displacer can be lengthened. This allows the temperature difference between the both ends of the second displacer to increase. Therefore, the cooling temperature of the second displacer can be lowered in comparison with a refrigerator having a structure to which the positional relationship between the low temperature cryopanel and the high temperature cryopanel is directly reflected.

In addition, the high temperature end of a regenerator material built in the second displacer is arranged so as to protrude into the first displacer. Thereby the amount of the regenerator material in the second displacer can be increased. In this way, the cooling capability achieved by the second displacer can also be increased.

Another aspect of the present invention is a cryogenic refrigerator. The cryogenic refrigerator includes a displacer coupling structure, wherein one of two coupled displacers protrudes into the other of the two coupled displacers to the extent that an end of a regenerator built in the one of the two coupled displacers positions itself inside of the other of the two coupled displacers.

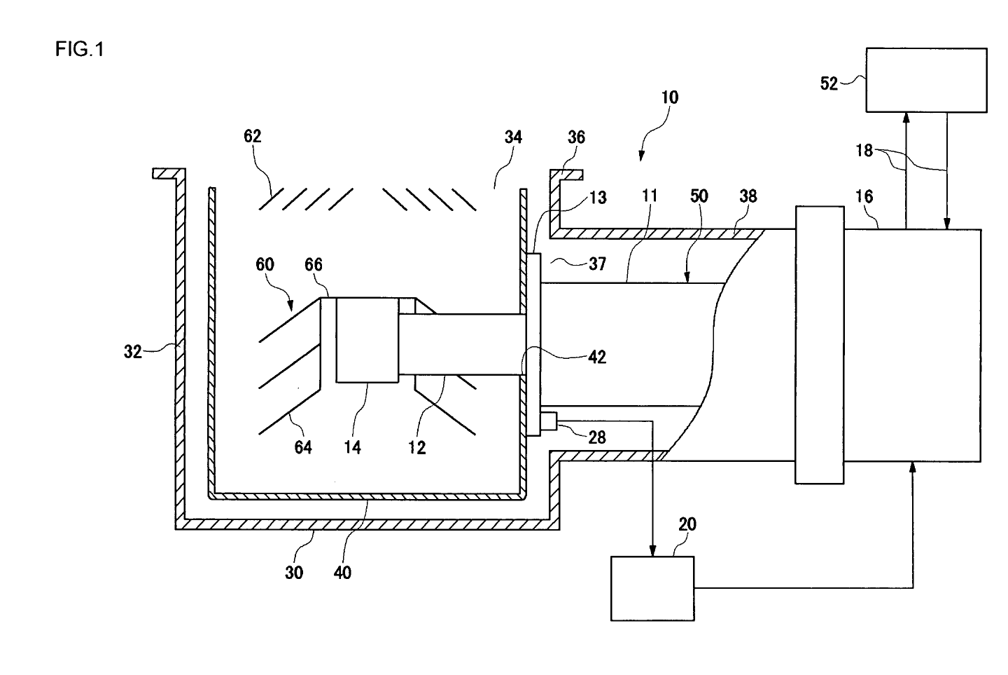

FIG. 1 schematically shows a cryopump 10 according to an exemplary embodiment of the present invention. The cryopump 10 is mounted to a vacuum chamber of an apparatus, such as an ion implantation apparatus, a sputtering apparatus, or the like that requires a high vacuum environment. The cryopump 10 is used to enhance the degree of vacuum in the vacuum chamber to a level required in a desired process. The cryopump 10 is configured to include a cryopump housing 30, a radiation shield 40, and a refrigerator 50.

The refrigerator 50 is, for example, a Gifford-McMahon refrigerator (so-called GM refrigerator) or the like. The refrigerator 50 is provided with a first cylinder 11, a second cylinder 12, a first cooling stage 13, a second cooling stage 14, and a valve drive motor 16. The first cylinder 11 and the second cylinder 12 are connected in series. The first cooling stage 13 is installed on one end of the first cylinder 11 where the first cylinder 11 is connected with the second cylinder 12. The second cooling stage 14 is installed on the second cylinder 12 at the end that is farthest from the first cylinder 11.

The refrigerator 50 shown in FIG. 1 is a two-stage refrigerator and achieves lower temperature by combining two cylinders in series. The refrigerator 50 may be a three-stage refrigerator that connects three stage cylinders in series, or may be a multiple-stage refrigerator having more than three stages. The refrigerator 50 is connected to a compressor 52 through a refrigerant pipe 18.

The compressor 52 compresses a refrigerant gas (i.e., an operating gas) such as helium or the like, and supplies the gas to the refrigerator 50 through the refrigerant pipe 18. While cooling the operating gas by allowing the gas to pass through a regenerator, the refrigerator 50 further cools the gas by expanding the gas in an expansion chamber inside the first cylinder 11 and in an expansion chamber in the second cylinder 12. Regenerators are installed inside the expansion chambers. Thereby, the first cooling stage 13 installed on the first cylinder 11 is cooled to a first cooling temperature level while the second cooling stage 14 installed on the second cylinder 12 is cooled to a second cooling temperature level lower than the first cooling temperature level. For example, the first cooling stage 13 is cooled to about 65-120 K, or more preferably 80-100 K, while the second cooling stage 14 is about 10-20 K.

In this way, the refrigerator 50 provides a low temperature cooling position for cooling the low temperature cryopanel and a high temperature cooling position for cooling the high temperature cryopanel. The low temperature cooling position and the high temperature cooling position are arranged along the longitudinal direction of the cylinders, that is, the alignment direction of the cylinders. One or a plurality of middle cooling positions that provide middle cooling temperature may be arranged between the low temperature cooling position and the high temperature cooling position.

The operating gas, which has absorbed heat by expanding in the respective expansion chambers sequentially and cooled respective cooling stages, passes through the regenerator again and is returned to the compressor 52 through the refrigerant pipe 18. The flow of the operating gas from the compressor 52 to the refrigerator 50 and from the refrigerator 50 to the compressor 52 is switched by a rotary valve (not shown) in the refrigerator 50. A valve drive motor 16 rotates the rotary valve by supplying power from an external power source.

A control unit 20 for controlling the refrigerator 50 is provided. The control unit 20 controls the refrigerator 50 based on the cooling temperature of the first cooling stage 13 or the second cooling stage 14. For this purpose, a temperature sensor 28 may be provided on the first cooling stage 13 or the second cooling stage 14. The control unit 20 may control the cooling temperature by controlling the driving frequency of the valve drive motor 16. For this purpose, the control unit 20 may include an inverter for controlling the valve drive motor 16. The control unit 20 may be configured so as to control the compressor 52. The control unit 20 may be integrated with the cryopump 10 or configured as a control device separate from the cryopump 10.

The cryopump 10 illustrated in FIG. 1 is a so-called horizontal-type cryopump. In the horizontal-type cryopump, the second cooling stage 14 of the refrigerator is generally inserted into the radiation shield 40 along the direction that intersects (usually orthogonally) with the axis of the cylindrical radiation shield 40. The present invention is also applicable to a so-called vertical-type cryopump in a similar way. In the vertical-type cryopump, the refrigerator is inserted along the axis of the radiation shield.

The cryopump housing 30 has a portion 32 formed into a cylindrical shape (hereinafter, referred to as a “trunk portion 32”), one end of which being provided with an opening and the other end being closed. The opening is provide as an inlet 34 through which a gas to be evacuated from the vacuum chamber of the sputtering apparatus or the like enters. The inlet 34 is defined by the interior surface of the upper end of the trunk portion 32 of the cryopump housing 30. On the trunk portion 32 also is formed an opening 37 for inserting the refrigerator 50. One end of a cylindrically-shaped refrigerator container 38 is fitted to the opening 37 in the trunk portion 32 while the other end thereof is fitted to the housing of the refrigerator 50. The refrigerator container 38 contains the first cylinder 11 of the refrigerator 50.

At the upper end of the trunk portion 32 of the cryopump housing 30, a mounting flange 36 extends outwardly in the radial direction. The cryopump 10 is mounted to the vacuum chamber, the content of which to be evacuated, of the sputtering apparatus or the like by using the mounting flange 36.

The cryopump housing 30 is provided in order to separate the inside of the cryopump 10 from the outside thereof. As described above, the cryopump housing 30 is configured to include the trunk portion 32 and the refrigerator container 38, and the trunk portion 32 and the refrigerator container 38 are airtight and the respective insides thereof are maintained at a common pressure. The exterior surface of the cryopump housing 30 is exposed to the environment outside the cryopump 10 during the operation of the cryopump 10, i.e., even during operation of the refrigerator. Therefore the exterior surface is maintained at a temperature higher than that of the radiation shield 40. The temperature of the cryopump housing 30 is typically maintained at an ambient temperature. Herein, the ambient temperature refers to a temperature of a place where the cryopump 10 is installed or a temperature close to the temperature. The ambient temperature may be, for example, at or around room temperature.

The radiation shield 40 is arranged inside the cryopump housing 30. The radiation shield 40 is formed as a cylindrical shape, one end of which being provided with an opening and the other end being closed, that is, a cup-like shape. The radiation shield 40 may be formed as a one-piece cylinder as illustrated in FIG. 1. Alternatively, a plurality of parts may form a cylindrical shape as a whole. The plurality of parts may be arranged so as to have a gap between one another.

The trunk portion 32 of the cryopump housing 30 and the radiation shield 40 are both formed as substantially cylindrical shapes and are arranged concentrically. The inner diameter of the trunk portion 32 of the cryopump housing 30 is larger than the outer diameter of the radiation shield 40 to some extent. Therefore, the radiation shield 40 is arranged in the cryopump housing 30 without contact, spaced reasonably apart from the interior surface of the cryopump housing 30. That is, the outer surface of the radiation shield 40 faces the inner surface of the cryopump housing 30. The shapes of the trunk portion 32 of the cryopump housing 30 and the radiation shield 40 are not limited to cylindrical but may be tubes having a rectangular or elliptical cross section, or any other cross section. Typically, the shape of the radiation shield 40 is analogous to the shape of the interior surface of the trunk portion 32 of the cryopump housing 30.

The radiation shield 40 is provided as a high temperature cryopanel to protect both the second cooling stage 14 and a low temperature cryopanel 60, which is thermally connected to the second cooling stage 14, from radiation heat mainly from the cryopump housing 30. The radiation shield 40 surrounds the low temperature cryopanel 60. The second cooling stage 14 is arranged inside the radiation shield 40, substantially on the central axis of the radiation shield 40. The radiation shield 40 is fixed to the first cooling stage 13 so as to be thermally connected to the stage, and the radiation shield 40 is cooled to a temperature comparable to that of the first cooling stage 13.

The low temperature cryopanel 60 includes, for example, a plurality of panels 64. Each of the panels 64 has a shape of the side surface of a truncated cone, i.e., an umbrella-like shape. Each panel 64 is attached to a panel mounting member 66 that is fixed to the second cooling stage 14. Typically, an adsorbent (not shown) such as activated carbon is provided on each panel 64. The adsorbent is adhered to, for example, the back face of the panel 64.

The panel mounting member 66 has a cylindrical shape, one end of which being closed and the other end being open. The closed end portion of the member is mounted at the upper end of the second cooling stage 14, and the cylindrical side surface of the member extends toward the bottom of the radiation shield 40 so as to surround the second cooling stage 14. The plurality of the panels 64 are attached to the cylindrical side surface of the panel mounting member 66 with spaces between one another. An opening for inserting the second cylinder 12 of the refrigerator 50 is formed on the cylindrical side surface of the panel mounting member 66.

A baffle 62 is provided in the inlet of the radiation shield 40 in order to protect both the second cooling stage 14 and the low temperature cryopanel 60, which is thermally connected to the stage, from radiation heat emitted from the vacuum chamber, etc. The baffle 62 is formed as, for example, a louver structure or a chevron structure. The baffle 62 may be formed as circular shapes concentrically arranged around the central axis of the radiation shield 40 or may be formed in another shape such as a lattice or the like. The baffle 62 is mounted at the opening end of the radiation shield 40 and cooled to a temperature comparable to that of the radiation shield 40. A gate valve (not shown) may be provided between the baffle 62 and the vacuum chamber. The gate valve is closed, for example, when the cryopump 10 is regenerated, and the gate valve is opened when the vacuum chamber is evacuated by the cryopump 10.

A refrigerator mounting opening 42 is formed on the side surface of the radiation shield 40. The refrigerator mounting opening 42 is formed on the side surface of the radiation shield 40 around the middle of the central axis of the radiation shield 40. The refrigerator mounting opening 42 of the radiation shield 40 is provided coaxially with the opening 37 of the cryopump housing 30. The second cylinder 12 and the second cooling stage 14 of the refrigerator 50 are inserted through the refrigerator mounting opening 42 in the direction perpendicular to the central axis of the radiation shield 40. The radiation shield 40 is fixed to the first cooling stage 13 so as to be thermally connected to the stage, at the refrigerator mounting opening 42.

As an alternative to the direct mounting of the radiation shield 40 to the first cooling stage 13, the radiation shield 40 may be mounted to the first cooling stage 13 by a connecting sleeve. The sleeve is, for example, a heat transfer member for surrounding one end of the second cylinder 12 at the first cooling stage 13 side and for thermally connecting the radiation shield 40 to the first cooling stage 13.

An explanation on the operations of the cryopump 10 with the aforementioned configuration will be given below. In operating the cryopump 10, the inside of the vacuum chamber is first roughly evacuated to approximately 1 Pa by another appropriate roughing pump before starting the operation. Thereafter, the cryopump 10 is operated. By driving the refrigerator 50, the first cooling stage 13 and the second cooling stage 14 are cooled, thereby the radiation shield 40, the baffle 62, and the cryopanel 60, which are thermally connected to the stages, are also cooled.

The cooled baffle 62 cools the gas molecules flowing from the vacuum chamber into the cryopump 10 such that a gas whose vapor pressure is sufficiently low at the cooling temperature (e.g., water vapor or the like) will be condensed on the surface of the baffle 62 and exhausted, accordingly. A gas whose vapor pressure is not sufficiently low at the cooling temperature of the baffle 62 enters into the radiation shield 40 through the baffle 62. Of the entering gas molecules, a gas whose vapor pressure is sufficiently low at the cooling temperature of the cryopanel 60 will be condensed on the surface of the cryopanel 60 and exhausted, accordingly. A gas whose vapor pressure is not sufficiently low at the cooling temperature (e.g., hydrogen or the like) is adsorbed by an adsorbent, which is adhered to the surface of the cryopanel 60 and cooled, and the gas is exhausted accordingly. In this way, the cryopump 10 can attain a desired degree of vacuum in the vacuum chamber.

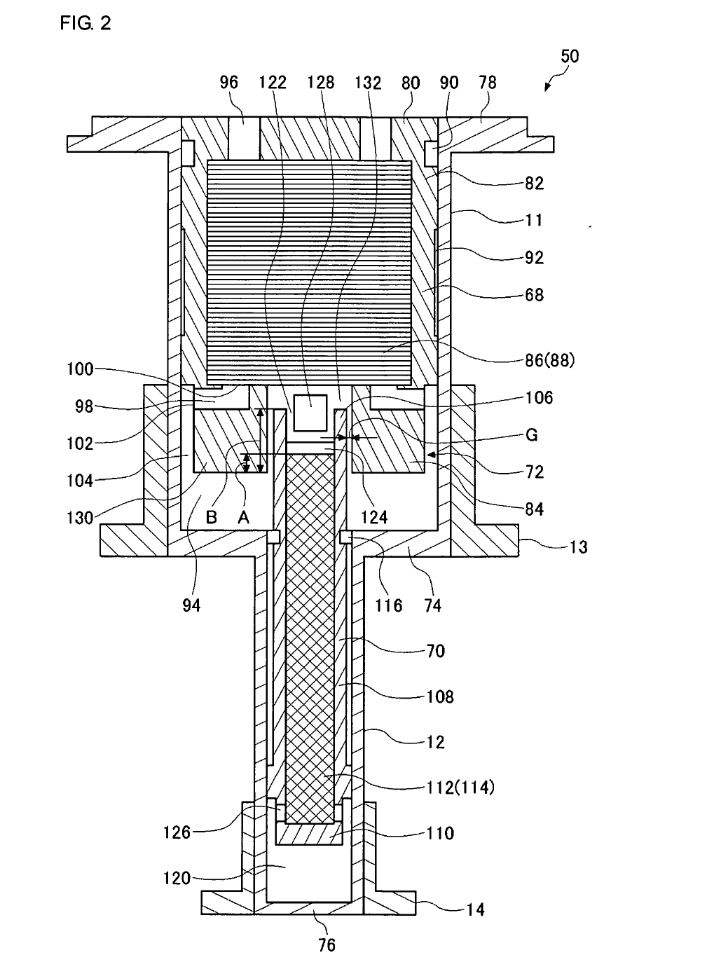

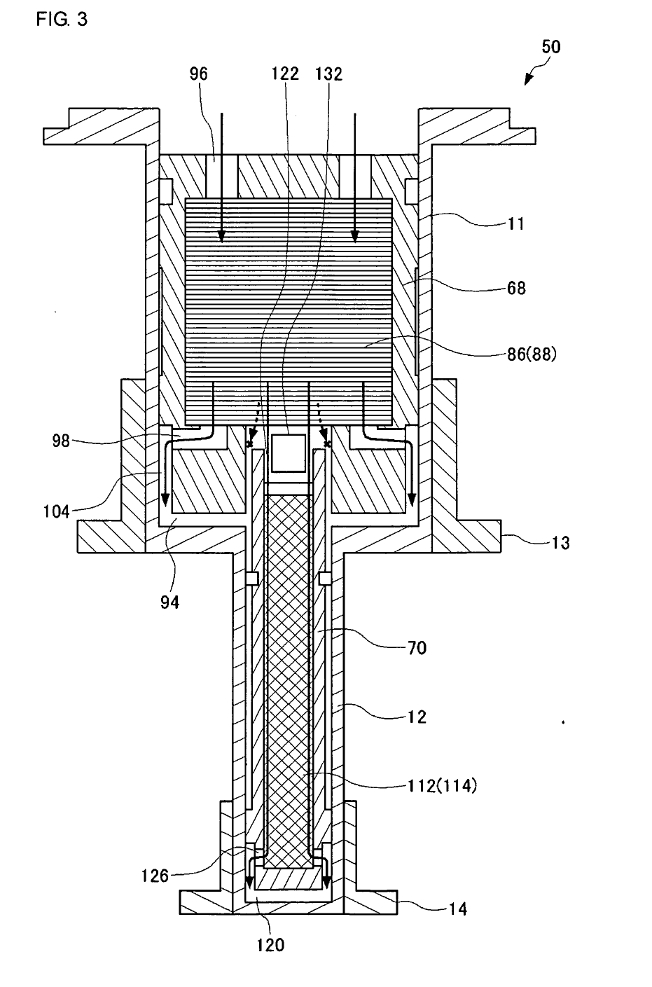

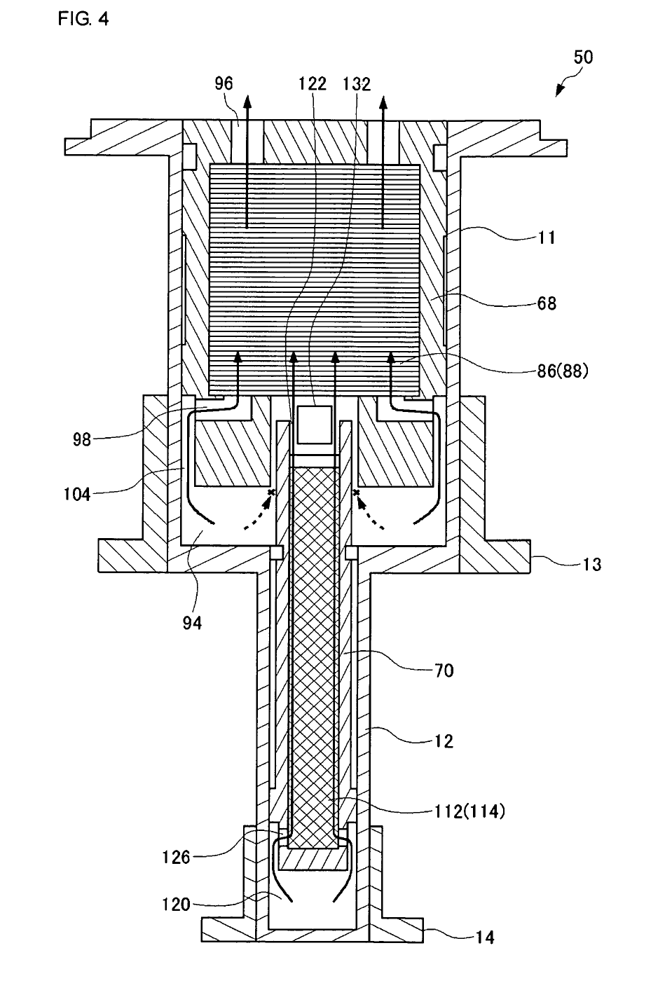

FIG. 2 to 4 show a substantial part of the refrigerator 50 according to an exemplary embodiment of the present invention. Respective figures show a cross sectional view including the central axis of the refrigerator 50. FIG. 3 schematically shows with arrows flows of operating gas during a gas intake process, and FIG. 4 schematically shows with arrows flows of the operating gas during a gas release process.

The refrigerator 50 includes a first displacer 68 and a second displacer 70 that are coupled with each other along the direction of the central axes (i.e., longitudinally). The first displacer 68 and the second displacer 70 are coupled by the joint unit 72. The refrigerator 50 includes a displacer coupling structure wherein the second displacer 70 protrudes into the first displacer 68 to the extent that the end of a regenerator material 112 included in the second displacer 70 positions itself inside of the first displacer 68.

The first cylinder 11 and the second cylinder 12 are formed integrally and the low temperature end of the first cylinder 11 and the high temperature end of the second cylinder 12 are connected by a first cylinder bottom 74. The first cylinder 11 and the second cylinder 12 are arranged in series along the longitudinal direction of the cylinders. The second cylinder 12 is a cylindrical member that is arranged coaxially with the first cylinder 11 and has a smaller radius than that of the first cylinder 11. The first cylinder 11 contains the first displacer 68 while allowing the first displacer 68 to move to and fro and the second cylinder 12 contains the second displacer 70 while allowing the second displacer 70 to move to and fro.

At the outer circumference of the low temperature end of the first cylinder 11, the first cooling stage 13 is attached and at the outer circumference of the low temperature end of the second cylinder 12, the second cooling stage 14 is attached. The first cylinder bottom 74 is a circular ring-shaped member that connects the first cylinder 11 and the second cylinder 12 with each other at their respective ends. The low temperature end of the second cylinder 12 is closed by a second cylinder bottom 76. At the outer circumference of the high temperature end of the first cylinder 11, a flange 78 is formed.

Adjacent to the high temperature end of the first cylinder 11, a drive mechanism comprising a valve drive motor 16, a rotary valve, and a Scotch Yoke mechanism is provided (not shown). The first displacer 68 is connected to the Scotch Yoke mechanism. The Scotch Yoke mechanism is driven by the valve drive motor 16. A rotational motion of the motor is changed into a linear reciprocating motion by the Scotch Yoke mechanism. Thereby the first displacer 68 moves to and fro along the inner surface of the first cylinder 11. Since the first displacer 68 and the second displacer 70 are coupled, the second displacer 70 also moves to and fro along the inner surface of the second cylinder 12, in synchronization with the first displacer 68.

The first displacer 68 is a member formed into a substantially cylindrical shape in correspondence with the inner volume and the shape of the first cylinder 11. The outer diameter of the first displacer 68 at the thickest portion thereof is substantially same as or slightly smaller than the inner diameter of the first cylinder 11. Thereby, the first displacer 68 can slide along the first cylinder 11, or can move without contact, while leaving a slight gap.

The first displacer 68 is configured to include a first high temperature end 80, a first cylindrical portion 82, and a first low temperature end 84. The first high temperature end 80 and the first low temperature end 84 close the end surfaces of the first cylindrical portion 82 respectively, the end surfaces being opposed to each other. As will be described later, an opening for connecting the inside and the outside of the first displacer 68 is formed on each of the first high temperature end 80 and the first low temperature end 84. A first stage regenerator material 86 is filled in the first cylindrical portion 82. The inner volume of the first displacer 68 surrounded by the first high temperature end 80, the first cylindrical portion 82, and the first low temperature end 84 can also be referred to as a first regenerator 88 that holds the regenerator material 86.

A circular groove for attaching a seal is formed on the outside in the radial direction at a portion of the first displacer 68 where the first high temperature end 80 and first cylindrical portion 82 is jointed, and a circular ring-shaped first seal 90 is attached in the groove. The first seal 90 closely contacts with the first cylinder 11 slidably, so as to block the flow of the operating gas at the outside of the first displacer 68 between the high temperature end of the first cylinder 11 and a first expansion space 94. At the outer circumference of the first cylindrical portion 82 of the first displacer 68, a fairly shallow concave portion 92 is formed in order to increase the thermal insulation against the outside of the cylinder. Adjacent to the first low temperature end 84, the first expansion space 94 is formed inside of the first cylinder 11. The first expansion space 94 changes its volume in accordance with the reciprocating movement of the first displacer 68.

At the first high temperature end 80 of the first displacer 68, a first opening 96 for allowing the operating gas to flow between the outside of the first displacer 68 (i.e., the high temperature side of the first cylinder 11) and the first regenerator 88 is formed. A plurality of first openings 96 are provided at a plurality of positions along the circumference around the central axis.

At the first low temperature end 84 of the first displacer 68, a second opening 98 for allowing the operating gas to flow between the first regenerator 88 and the first expansion space 94 is formed. A plurality of second openings 98 are provided at a plurality of positions on the outer perimeter of the first low temperature end 84, along the circumference around the central axis. An inlet portion 100 of the second opening 98 is formed at the low temperature end of the first regenerator 88, and an outlet portion 102 of the second opening 98 is formed at the side surface of the first low temperature end 84. A curved flow passage is formed from the inlet portion 100 to the outlet portion 102 at the first low temperature end 84. The inlet portion 100 and the outlet portion 102 are merely named as such for the sake of convenience. That is, at the second opening 98, not only the operating gas flow from the inlet portion 100 to the outlet portion 102, but also the operating gas flow from the outlet portion 102 to the inlet portion 100 is permitted. The second opening 98 may not be the curved flow passage but may also be, for example, a straight through hole formed at the low temperature end of the first regenerator 88, along the direction of the central axis or the direction orthogonal thereto.

The diameter of the first low temperature end 84 of the first displacer 68 is set, to some extent, smaller than that of the low temperature end of the first cylindrical portion 82. Thereby, a circular ring-shaped first passage 104 that connects the second opening 98 and the first expansion space 94 is formed between the side surface of the first low temperature end 84 and the inner surface of the first cylinder 11. The first passage 104 may also be deemed as a part of the first expansion space 94. By the first passage 104, the outlet portion 102 of the second opening 98 is connected to the first expansion space 94.

The first passage 104 extends longitudinally along the first cooling stage 13. As shown in the figures, the longitudinal extent of the first cooling stage 13 includes the longitudinal range of movement of the outlet portion 102 of the second opening 98. Therefore, regardless of the longitudinal position of the first displacer 68, the outlet portion 102 of the second opening 98 opposes to the first cooling stage 13. In this way, the operating gas flowing through the first passage 104 and the first cooling stage 13 can exchange heat with each other through the first cylinder 11, efficiently.

In this way, a first flow passage for allowing the operating gas to flow from the first displacer 68 through the second opening 98 to the first expansion space 94 is formed. This first flow passage delivers the operating gas from the compressor 52 and the refrigerant pipe 18 (cf. FIG. 1), through the first opening 96, the first regenerator 88, the second opening 98, and the first passage 104, to the first expansion space 94 (cf. FIG. 3). The first flow passage returns the operating gas in the reverse direction from the first expansion space 94 to the compressor 52 (cf. FIG. 4).

The second displacer 70 is a member formed into a substantially cylindrical shape in correspondence with the inner volume and the shape of the second cylinder 12. The outer diameter of the second displacer 70 at the thickest portion thereof is substantially same as or slightly smaller than the inner diameter of the second cylinder 12. Thereby, the second displacer 70 can slide along the second cylinder 12, or can move without contact, while leaving a slight gap.

The second displacer 70 is configured to include a second high temperature end 106, a second cylindrical portion 108, and a second low temperature end 110. The second high temperature end 106 and the second low temperature end 110 close the end surfaces of the second cylindrical portion 108 respectively, the end surfaces being opposed to each other. As will be described later, an opening for connecting the inside and the outside of the second displacer 70 is formed on each of the second high temperature end 106 and the second low temperature end 110. A second stage regenerator material 112 is filled in the second cylindrical portion 108. Inner volume of the second displacer 70 surrounded by the second high temperature end 106, the second cylindrical portion 108, and the second low temperature end 110 can also be referred to as a second regenerator 114 holding the regenerator material 112. At the high temperature side of the second regenerator 114, a piece of felt or a metal mesh 124 for holding the regenerator material 112 is provided. In the similar manner, a piece of felt or a metal mesh may be contained also in the low-temperature end.

A circular groove for attaching a seal is formed on the outside in the radial direction of the second cylindrical portion 108 of the second displacer 70, and a circular ring-shaped second seal 116 is attached therein. The second seal 116 closely contacts with the second cylinder 12 slidably over the movable range of the second displacer 70, so as to block the flow of the operating gas at the outside of the second displacer 70 between the first expansion space 94 and a second expansion space 120. At the outer circumference of the second cylindrical portion 108 of the second displacer 70, a fairly shallow concave portion 118 is formed in order to increase the thermal insulation against the outside of the cylinder. Adjacent to the second low temperature end 110, the second expansion space 120 is formed inside of the second cylinder 12. The second expansion space 120 changes the volume thereof in accordance with the reciprocating movement of the second displacer 70.

At the second high temperature end 106 of the second displacer 70, a third opening 122 for allowing the operating gas to flow between the outside of the second displacer 70 (i.e., the low temperature side of the first displacer 68) and the second regenerator 114 is formed. A plurality of third openings 122 are provided at a plurality of positions along the circumference around the central axis. Alternatively, the third opening 122 is provided at around the entire perimeter.

At the second low temperature end 110 of the second displacer 70, a fourth opening 126 for allowing the operating gas to flow between the second regenerator 114 and the second expansion space 120 is formed. A plurality of fourth openings 126 are provided at a plurality of positions at the side surface of the second low temperature end 110. Also a flow passage that connects the fourth opening 126 to the second expansion space 120 is provided along the second cooling stage 14 in a similar manner as the first passage 104. Thereby the operating gas flowing from the second expansion space 120 to the second regenerator 114 and the second cooling stage 14 can effectively exchange heat with each other.

As described above, the first displacer 68 and the second displacer 70 are coupled with each other along the longitudinal direction thereof by the joint unit 72. The second high temperature end 106 of the second displacer 70 is contained in the first low temperature end 84 of the first displacer 68 so that the high temperature end of the second regenerator 114 protrudes into the first displacer 68. As shown in the figures, the end surface at the high temperature side of the second regenerator 114 protrudes further than the end surface of the first low temperature end 84 by the length A. To provide this, the end surface of the second high temperature end 106 of the second displacer 70 protrudes further than the end surface of the first low temperature end 84 of the first displacer 68 by the lengths B. The length B is at least 15 mm.

By arranging the second displacer 70 so that the second displacer 70 protrudes into the first displacer 68, the second displacer 70 can be lengthened without increasing the length of the second cylinder 12. By lengthening the second displacer 70, the distance between the high temperature end of the second displacer 70 and the low temperature end thereof is stretched, thus, the temperature difference can be increased. That is, the temperature of the low temperature end can be lowered. Further, the amount of the regenerator material 112 filled in the second regenerator 114 can be increased. The specific heat of the second regenerator 114 is increased, and the cooling capacity of the second cylinder of the refrigerator 50 can be enhanced.

By arranging the second displacer 70 so that the second displacer 70 protrudes into the first displacer 68, the shape and the size of an existing cylinder can also be maintained. Therefore, the movable range of the displacers (so-called “stroke”) can also be maintained, and no change is required in the design of the drive mechanism of the refrigerator 50. Further, since the shape and the size of an existing cylinder can be maintained, an effect on the structural design of an apparatus to which the refrigerator 50 is applied is limited or absent. For example, in the cryopump 10, the pumping capability of the low temperature cryopanel 60 can be increased while the positional relation between the radiation shield 40 and the low temperature cryopanel 60 is maintained.

The joint unit 72 includes a connector member 128. The first low temperature end 84 of the first displacer 68 and the second high temperature end 106 of the second displacer 70 are coupled via the connector member 128 of a cylindrical column shape or a polygonal column shape. Two coupling pins are inserted through at the both ends of the connector member 128. One pin couples the first low temperature end 84 of the first displacer 68 and the connector member 128, and the other pin couples the second high temperature end 106 of the second displacer 70 and the connector member 128. The directions of insertion of the two pins are both orthogonal to the longitudinal direction of the refrigerator 50. According to an exemplary embodiment, the joint unit 72 may include a so-called universal coupling joint.

In this way, the first displacer 68 and the connector member 128 are coupled via the one coupling pin swingably. In the direction orthogonal thereto, the second displacer 70 and the connector member 128 are coupled via the other coupling pin swingably. Thus, when the first displacer 68 and the second displacer 70 is inserted into the first cylinder 11 and the second cylinder 12 respectively during the assembling process of the refrigerator 50, the second displacer 70 can move or can be decentered with respect to the first displacer 68 to some extent. Therefore, the tolerance of the manufacturing process of the cylinders is relaxed, which contributes to the cost reduction of the refrigerator 50.

The first low temperature end 84 of the first displacer 68 has an outer circumference portion 130. The outer circumference portion 130 is formed as a circular shaped convex portion that protrudes from the first cylindrical portion 82 to the first cylinder bottom 74. The side surface of the outer circumference portion 130 is also the side surface of the first low temperature end 84. Thus, the side surface of the outer circumference portion 130 opposes to the inner surface of the first cylinder 11, and the first passage 104 described above is formed between the side surface of the outer circumference portion 130 and the inner surface of the first cylinder 11, accordingly. The central portion surrounded by the outer circumference portion 130 is a concave portion 132. The concave portion 132 is open to the first regenerator 88. Alternatively, an opening that connects the concave portion 132 and the low temperature end of the first regenerator 88 may be formed at the central portion of the first low temperature end 84, that is, on the upper surface of the concave portion 132.

The connector member 128 is arranged in the concave portion 132 and the entire connector member 128 is contained in the concave portion 132. The joint portion of the connector member 128 coupling with the second displacer 70 is contained in the third opening 122 of the second displacer 70. There is a gap between the lower end of the connector member 128 and the second regenerator 114 or the metal mesh 124, thus the connector member 128 and the second regenerator 114 or the metal mesh 124 do not contact with each other.

The concave portion 132 of the first low temperature end 84 is formed in order to receive the second displacer 70. The high temperature end of the second displacer 70, more specifically, the second high temperature end 106 and the high temperature end of the second cylindrical portion 108 are inserted into the concave portion 132, i.e., inserted while allowing a looseness to some extent. Therefore, a gap G is formed between the side surface of the concave portion 132, and the second high temperature end 106 and the side surface of the second cylindrical portion 108 of the second displacer 70. The difference between the diameter of the concave portion 132 and the diameter of the second cylindrical portion 108 defines the gap G. The gap G is comparable to or less than 1 mm, and more preferably, is comparable to or less than 0.5 mm.

Thus, a direct flow passage is formed for allowing the operating gas to flow from the first displacer 68 through the concave portion 132 to the second displacer 70. The direct flow passage delivers the operating gas from the compressor 52 and the refrigerant pipe 18 (cf. FIG. 1), through the first opening 96, the first regenerator 88, the concave portion 132, the third opening 122, the second regenerator 114 and the fourth opening 126, to the second expansion space 120 (cf. FIG. 3).

Further, the direct flow passage returns the operating gas in the reverse direction from the second expansion space 120 to the compressor 52 (cf. FIG. 4).

The size of the gap G is adjusted so that the operating gas flowing through the direct flow passage dominates the flow the operating gas between the first displacer 68 and the second displacer 70. In this way, a leakage through the gap G of the operating gas flowing between the first regenerator 88 and the second regenerator 114 can be restrained. The amount of the operating gas directly flowing from the first regenerator 88 to the second regenerator 114 without passing through the first expansion space 94 can be increased.

The gap G connects from the concave portion 132 to the first expansion space 94. The first expansion space 94 is a space surrounded by the first displacer 68, the first cylinder 11, and the second displacer 70. More specifically, the first expansion space 94 is defined by the first low temperature end 84 of the first displacer 68, the inner surface of the first cylinder 11, and the second cylindrical portion 108 of the second displacer 70 that extends from the concave portion 132 of the first displacer 68.

The size of the gap G is adjusted so that the flow of the operating gas through the second opening 98 dominates the flow of the operating gas between the first expansion space 94 and the first displacer 68. That is, the operating gas flowing from the first displacer 68 through the second opening 98 to the first expansion space 94 is returned to the first displacer 68 by passing through the second opening 98 again. The flow of gas flowing via the first expansion space 94 through the gap G into the concave portion 132 is sufficiently restrained.

In this way, the flow of the operating gas to the first expansion space 94 and the flow of the operating gas to the second expansion space 120 are separated from each other. Therefore, the operating gas that flows into the first expansion space 94 and exchange heat with the first cooling stage 13 is restrained from flowing into the second displacer 70. The operating gas being supplied from the first displacer 68 and heading directly to the second expansion space 120 does not pass through the first expansion space 94. In this way, the effect that the cooling temperature of the first stage of the refrigerator 50 gives to the cooling capability of the second stage can be reduced.

The aforementioned structure wherein the flows of gas are separated from each other is particularly preferable in case where a large temperature difference between the different cooling stages is required. In case that the operating gas passes through a cooling stage that is cooled to a comparatively high temperature and a heat exchanger (i.e., an expansion space) of the cooling stage and heads for a next cooling stage of comparatively low temperature and a heat exchanger thereof, the effect that the high temperature of the upstream stage gives to the downstream stage becomes large. By separating the flow, the effect given to the cooling capability of the downstream stage can be restrained.

Therefore, for example, for the refrigerator 50 having two stages, it is preferable to adopt the aforementioned flow-separating structure in case the cooling temperature of the first stage is set to be comparable to or more than 80 K, preferably comparable to or more than 100 K, and the cooling temperature of the second stage is set to be comparable to or less than 30 K, preferably comparable to or less than 20 K. Alternatively, it is preferable to adopt the flow-separating structure in case the temperature difference between the stages adjacent to each other is large, for example, at least comparable to or more than 50 K, preferably comparable to or more than 80 K.

The respective flow passages are configured so that the direction of the flow of the operating gas flowing out from the first displacer 68 through the direct flow passage to the second expansion space 120 and the direction of the flow of the operating gas flowing out from the first displacer 68 and heading to the first expansion space 94 are aligned in parallel. The concave portion 132 is formed so that the flow of gas heading from the first regenerator 88 to the second regenerator 114 flows longitudinally, and the inlet portion 100 of the second opening 98 is also formed so that the flow of gas from the first regenerator 88 flows longitudinally. The concave portion 132 and the inlet portion 100 of the second opening 98 is an opening formed in parallel to the central axis of the cylinder. As described above, the operating gas flowing into the second opening 98 is curved in the outward radial direction inside the second opening 98 and flows out from the outlet portion 102. That is, the direction of the flow of gas is changed outside of the first regenerator 88.

In this way, the openings is formed so that the directions of the flows of gas running from the low temperature end of the first regenerator 88 to the outside are aligned in parallel. Thereby, the consistency of the flows of operating gas at the low temperature end of the first regenerator 88 can be increased. By increasing the consistency of the flows of the operating gas, the uniformity of the temperature distribution at the low temperature end of the first regenerator 88 is refined. This is thought to contribute to the maintenance of the low temperature at the entire low temperature end of the first regenerator 88.

An explanation will be given on the operation of the refrigerator 50. The intake process shown in FIG. 3 and the release process shown in FIG. 4 are regarded as one cycle and the refrigerator 50 repeats the cycle. At a certain time point during the intake process, the first displacer 68 and the second displacer 70 reach the bottom dead centers of the first cylinder 11 and the second cylinder 12, respectively. At the same time or slightly earlier or later, the discharge side of the compressor 52 and the inner volume of the cylinder are connected with each other by the rotary valve, and a high-pressure operating gas (e.g., a helium gas) from the compressor 52 flows into the first displacer 68, accordingly. The high-pressure helium gas flows from the first opening 96 to the first regenerator 88, and is cooled by the regenerator material 86. A part of the cooled helium gas flows into the first expansion space 94 through the second opening 98 and the first passage 104.

The rest of the cooled helium gas flows through the concave portion 132 of the first displacer 68, and the third opening 122 of the second displacer 70, into the second regenerator 114. The helium gas is cooled by the regenerator material 112 in the second regenerator 114 and flows through the fourth opening 126 into the second expansion space 120. In this way, the gas in the first expansion space 94 and the second expansion space 120 becomes high pressure, respectively. By allowing the first displacer 68 and the second displacer 70 to move towards the top dead centers, the first expansion space 94 and the second expansion space 120 are expanded. The expanded first expansion space 94 and the second expansion space 120 are filled with the high-pressure helium gas.

At a certain time point during the release process, the first displacer 68 and the second displacer 70 position themselves at the top dead centers of the first cylinder 11 and the second cylinder 12, respectively. At the same time or slightly earlier or later, the suction side of the compressor 52 and the inner volume of the cylinder are connected with each other by the rotation of the rotary valve. The helium gas in the first expansion space 94 and the second expansion space 120 are decompressed and expanded. By the expansion, the pressure of the helium gas decreases and cooling occurs. The helium gas in the first expansion space 94 absorbs heat from the first cooling stage 13 and thus cools the first cooling stage 13, and the helium gas in the second expansion space 120 absorbs heat from the second cooling stage 14 and thus cools the second cooling stage 14.

The first displacer 68 and the second displacer 70 are moved towards the bottom dead center and the first expansion space 94 and the second expansion space 120 are reduced, accordingly. The low pressure helium gas is returned from the first expansion space 94, through the first passage 104, the second opening 98, the first regenerator 88, and the first opening 96, to the compressor 52 and is collected. Further, the low-pressure helium gas is returned from the second expansion space 120, through the fourth opening 126, the second regenerator 114, the third opening 122, the concave portion 132, the first regenerator 88, and the first opening 96, to the compressor 52 and is collected. In this process, the regenerator material 86 of the first regenerator 88 and the regenerator material 112 of the second regenerator 114 are also cooled.

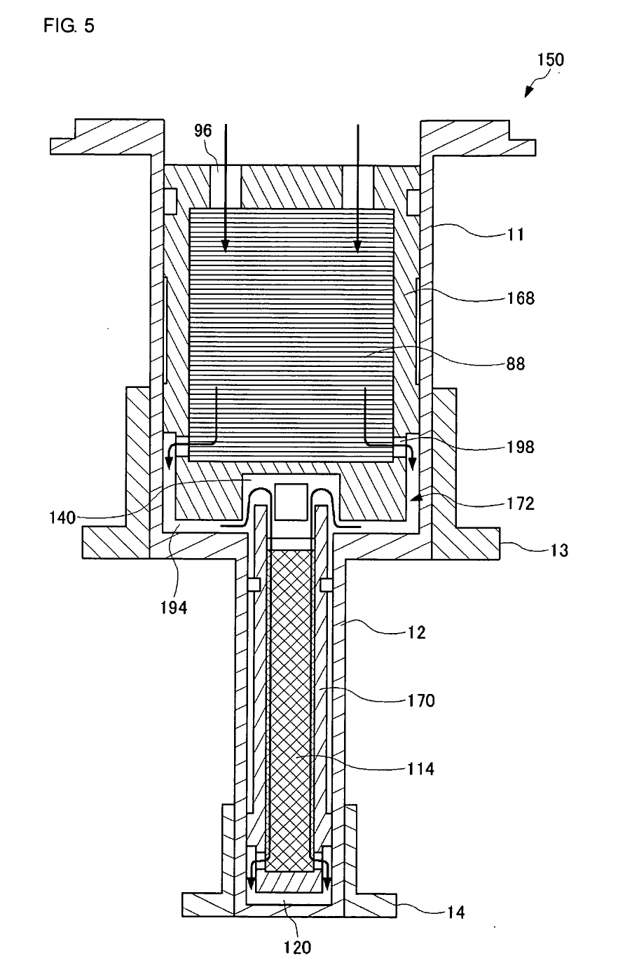

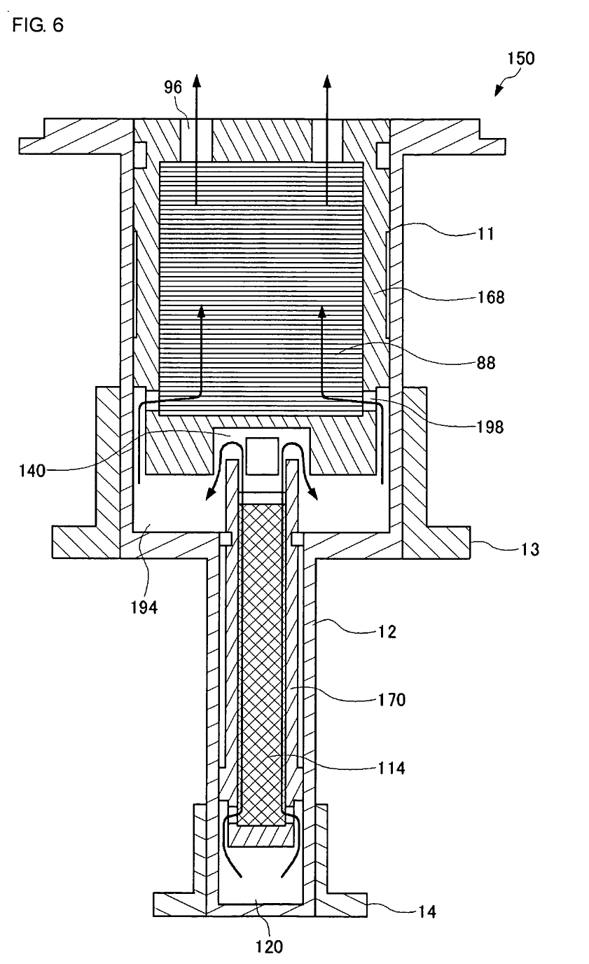

FIG. 5 shows a gas intake process of another typical refrigerator 150, and FIG. 6 shows a gas release process of the refrigerator 150. The structure of the refrigerator 150 differs from that of the refrigerator 50 shown in FIG. 2 with respect to a joint unit 172 coupling a first displacer 168 and a second displacer 170. The first cylinders 11, the second cylinders 12, the first cooling stages 13, and the second cooling stages 14 of the refrigerator 50 shown in FIG. 2 and of the refrigerator 150 shown in FIG. 6 are of same size and shape.

In the refrigerator 150, a coupling cavity 140, which is a space between the first displacer 168 and the second displacer 170, is formed as a flow passage that connects a first expansion space 194 and a second regenerator 114 as shown in FIG. 5 and FIG. 6. Thus, the high temperature end of the second displacer 170 protrudes slightly into the coupling cavity 140 of the low temperature end of the first displacer 168. The amount of the protrusion is at the longest, 10 mm. Therefore, the second regenerator 114 positions itself outside of the first displacer 168.

In order to assure a sufficient flux of the flow into the second displacer 170, a clearance between the second displacer 170 and the first displacer 168 at the protrusion portion is defined as at least more than 2 mm or 3 mm. In case of putting a high priority on designing a large amount of a relative movement with respect to each other between the two displacers during assembling work, the high temperature end of the second displacer 170 does not protrudes into the low temperature end of the first displacer 168 and arranged outside of the coupling cavity 140.

Therefore, during the gas intake process, the flow of the operating gas is supplied through the first opening 96, the first regenerator 88, a second opening 198, the first expansion space 194, the coupling cavity 140, and the second regenerator 114, to the second expansion space 120 (cf. FIG. 5). During the gas release process, the operating gas flows in the reverse direction and returns from the second expansion space 120 to the first opening 96 (cf. FIG. 6). In this way, the flow of the operating gas between the first regenerator 88 and the second regenerator 114 passes through the first expansion space 194. Therefore, the cooling capability of the second stage of the refrigerator 150 is susceptible to the cooling temperature of the first stage.

In the refrigerator 150, the second opening 198 is formed at the low temperature side surface of the first displacer 168 in order to connect the first regenerator 88 of the first displacer 168 to the first expansion space 194. A plurality of second openings 198 are formed at a plurality of positions on the side surface of the first displacer 168 in a radial pattern around the central axis of the refrigerator 150. The second opening 198 can be introduced to the refrigerator 50 shown in FIG. 2.

As will be understood from the comparison with the refrigerator 150 shown in FIG. 5 and FIG. 6, the joint unit 72 of the refrigerator 50 shown in FIG. 2 to FIG. 4 can also be referred to as having a seal structure that seals the flow of gas at the gap G connecting from the first expansion space 94, which is adjacent to the first displacer 68, to the second displacer 70. In the seal structure, the end of one of the two adjacent displacers is inserted, with a slight gap, into the concave portion provided on the other of the two displacers that receives the end of the one of the two displacers. The gap between them is adjusted as a clearance for sealing the flow of operating gas to/from the outside of the displacer coupling structure. The clearance is provided to permit a slight relative displacement during the assembling of the refrigerator.

As an index indicating the sealing performance of the seal structure, the ratio X of a protrusion length B of the second displacer 70 to the gap G. That is, X=B/G. If the protrusion length B of the second displacer 70 is large and the gap G is small, the value X of the ratio becomes large. In this case, the degree of meandering of the passage connecting the first expansion space 94 and the second regenerator 114 increases. Therefore, the flow of the operating gas is constrained.

Meanwhile, if the protrusion length B of the second displacer 70 is small and the gap G is large, the value X of the ratio becomes small. In this case, the meandering of the passage is small, and the operating gas flows easily.

According to an exemplary embodiment, the ratio X is preferably comparable to or more than 10. In case the protrusion length B is 15 mm and the gap G is 1 mm, the ratio X becomes 15, and in case the protrusion length B is 15 mm and the gap G is 0.5 mm, the ratio X becomes 30. Therefore, the ratio X is preferably, at least comparable to or more than 30. In contrast, in case that the protrusion length B is 10 mm and the gap G is 2 to 3 mm such as the case of the refrigerator 150 shown in FIG. 5 and FIG. 6, the ratio X becomes 3.3 to 5. By setting the ratio value X ten or more times greater than that of a joint portion of a typical refrigerator in the aforementioned manner, a sufficient sealing performance can be achieved.

According to a preferable exemplary embodiment, the protrusion length B is at least 15 mm and the ratio X is at least 10, preferably at least 30. By defining the lower limit of the ratio X on the precondition that the protrusion length B of the second displacer 70 is defined as at least 15 mm, the gap G can be defined sufficiently narrow.

As described above, according to an exemplary embodiment of the present invention, in an arrangement of a refrigerator in which the positions of two cooling stages and the size of cylinders are generally predefined, the second displacer 70 can be further lengthened. This allows the distance between a high temperature end and a low temperature end to increase, thus allows the temperature difference to increase. Further, the amount of regenerator material built in the displacer can be increased so as to increase the cooling capability. Since a cryopump includes a radiation shield and a cryopanel therein, whose positional relation is predetermined, the refrigerator aforementioned above can be favorably applied to a cryopump. More specifically, the refrigerator is favorably applied to a cryopump in case the temperature difference between the radiation shield and the cryopanel therein is required to be large.

It should be understood that the invention is not limited to the above-described embodiment, but may be modified into various forms on the basis of the spirit of the invention. Additionally, the modifications are included in the scope of the invention.

Priority is claimed to Japanese Patent Application No. 2010-204891, filed Sep. 13, 2010, the entire content of which is incorporated herein by reference.

What is claimed is:

1. A cryopump comprising:
a low temperature cryopanel;
a high temperature cryopanel arranged to be cooled to a temperature higher than that of the low temperature cryopanel; and
a refrigerator arranged to provide a low temperature cooling position for cooling the low temperature cryopanel and a high temperature cooling position for cooling the high temperature cryopanel, the low temperature cooling position and the high temperature cooling position being arranged longitudinally,
wherein the refrigerator comprises a first displacer and a second displacer coupled with each other longitudinally, wherein a high temperature end of the second displacer is contained in and coupled to a low temperature end of the first displacer so that a high temperature end of a regenerator built in the second displacer protrudes into the first displacer.

2. The cryopump according to claim 1, wherein the second displacer protrudes into the first displacer by at least 15 mm.

3. The cryopump according to claim 1, wherein
a concave portion for receiving the second displacer is formed at the low temperature end of the first displacer, and the high temperature end of the second displacer is inserted into the concave portion, and
a direct flow passage is formed for allowing an operating gas to flow from the first displacer to the second displacer through the concave portion, and a gap between the high temperature end of the second displacer and the concave portion is adjusted so that a flow of gas through the direct flow passage dominates a flow of gas between the first displacer and the second displacer.

4. The cryopump according to claim 3, wherein an opening is formed at the low temperature end of the first displacer so as to lead the operating gas to an adjacent first expansion space, and
the gap is adjusted so that a flow of gas through the opening dominates a flow of gas between the first expansion space and the first displacer.

5. The cryopump according to claim 4, wherein the direction of the opening is defined so that the direction of the gas flowing through the direct flow passage from the first displacer and the gas flowing through the opening from the first displacer are aligned in parallel.

6. The cryopump according to claim 1, wherein the refrigerator comprises a joint unit that couples the first displacer and the second displacer and that is provided with a seal structure which seals a gap penetrating from the first expansion space adjacent to the first displacer to the second displacer.

7. A cryogenic refrigerator comprising a displacer coupling structure, wherein one of two coupled displacers protrudes into the other of the two coupled displacers to the extent that an end of a regenerator built in the one of the two coupled displacers positions itself inside of the other of the two coupled displacers.
